(19) United States
(12) Patent Application Publication
(10) Pub. No.: US 2006/0058070 A1
(43) Pub. Date: Mar. 16, 2006

(54) Universal device with means of holding a portable electronic device and communicating therewith

(76) Inventor: Ta Shuo Chang, Taipei (TW)

Correspondence Address: BRUCE H. TROXELL;SUITE 1404, 5205 LEESBURG PIKE, FALLS CHURCH, VA, 22041, US

(21) Appl. No.: 10/952,841

(22) Filed: Sep. 30, 2004

(30) Foreign Application Priority Data
Sep. 10, 2004 (TW) 093214524

(51) Int. Cl. H04B 1/00

(52) U.S. Cl. 455/569.1

(57) ABSTRACT

Provided is a universal device comprising a main body including a plurality of connecting sections including an upper plate and a lower plate in which devices including a built-in speaker, a transceiver unit such as a piece of GPS equipment or a wireless transceiver, a swivel coupling assembly adapted to couple to a hands-free device, a cradle for holding a portable electronic device such as a cellular phone, a PDA, a Smart Phone having the features of cellular phone and PDA, and a Palmtop, and a communication unit are releasably coupled to the upper or the lower plate or formed thereon. The invention permits a user to selectively couple the portable electronic device and/or the hands-free device to the universal device for communicating therewith.

### BACKGROUND OF THE INVENTION

1. Field of the Invention

The present invention relates to devices adapted to assemble with other pieces of equipment, and more particularly to a universal device comprising a main body including a plurality of connecting sections having an upper plate and a lower plate, a built-in speaker, a transceiver unit such as a piece of GPS (Global Positioning System) equipment or a wireless transceiver, a swivel coupling assembly adapted to couple to a hands-free device, a cradle for holding a portable electronic device, and a communication unit for communicating therewith.

2. Description of Related Art

A wide variety of portable electronic products such as cellular phones, PDAs (personal digital assistants), Smart Phones having the features of cellular phone and PDA, and Palmtops are available due to technological advancements of electronics. Such products bring a lot of convenience to our daily work and life. Moreover, many intelligent, multifunctional products such ones incorporating features of MP3, GPS, camera, and video recording are developed in recent years.

However, many restrictions still impose on portable electronic products. For example, many countries have laws prohibiting the use of cellular phone while driving. But it is lawful in some countries to fit a hands-free device and a cradle in a car so that a call can be received while driving. Moreover, some cars have a GPS device mounted therein for ease of finding direction while driving.

Conventionally, available holding devices only have the function of holding a portable electronic product, i.e., they are holders only. As to other features such as MP3, GPS, or the like, they are not available. For incorporating any of the above features into an existing portable electronic product, a speaker, a receiver for GPS, etc. are required to install therein. This may complicate the construction. Moreover, wires associated therewith may be messy. This is not desirable. Unfortunately, nothing in the prior art provides a solution to the above. Thus, it is desirable to provide a universal device with means of holding and communicating with a portable electronic device and being capable of selectively coupling to a hands-free device so as to provide other advantageous features and more.

### SUMMARY OF THE INVENTION

It is an object of the present invention to provide a universal device comprising a main body comprising a plurality of connecting sections including an upper plate and a lower plate; a cradle releasably coupled to both the upper plate and a portable electronic device held thereon; a signal processing module extended from a rear end of the upper plate; a communication unit releasably coupled to the signal processing module and being adapted to electrically coupled to the portable electronic device; a pivotal swivel joint formed at a front end of the main body; a transceiver unit coupled to the joint; and a swivel coupling assembly formed on the lower plate, the coupling assembly being adapted to hold a hands-free device thereon.

The above and other objects, features and advantages of the present invention will become apparent from the following detailed description taken with the accompanying drawings.

### BRIEF DESCRIPTION OF THE DRAWINGS

FIG. 1 is an exploded, perspective view of a first preferred embodiment of universal device according to the invention;

FIG. 2 is a perspective view of the assembled universal device of FIG. 1

FIG. 3 is an exploded, perspective view depicting the cradle to be assembled with the main body of the universal device;

FIG. 4 is a perspective view depicting the communication unit to be installed on the main body of the universal device;

FIG. 5 is a perspective view depicting the assembled communication unit and the main body of the universal device;

FIG. 6 is an exploded, perspective view depicting the coupled main body and the transceiver unit separate from the coupled cradle and the communication unit;

FIG. 6A is an exploded view of the transceiver unit;

FIG. 7 is an exploded, perspective view depicting bottom portion of the universal device for illustrating components of the coupling assembly;

FIG. 8 is a perspective view of assembled coupling assembly of the universal device as shown in FIG. 7;

FIG. 9 is a side view depicting a pivoting operation of the transceiver unit with respect to the main body;

FIG. 10 is a perspective view depicting a swiveling operation of the transceiver unit;

FIG. 11 is an exploded, perspective view of a second preferred embodiment of universal device according to the invention; and

FIG. 12 is a perspective view of the assembled universal device of FIG. 11.

### DETAILED DESCRIPTION OF THE PREFERRED EMBODIMENTS

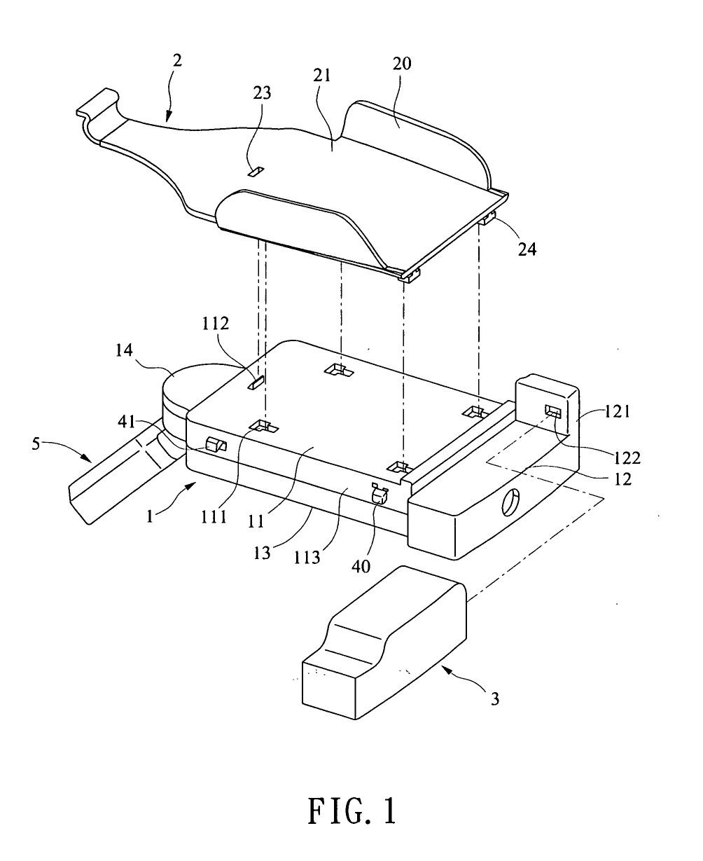

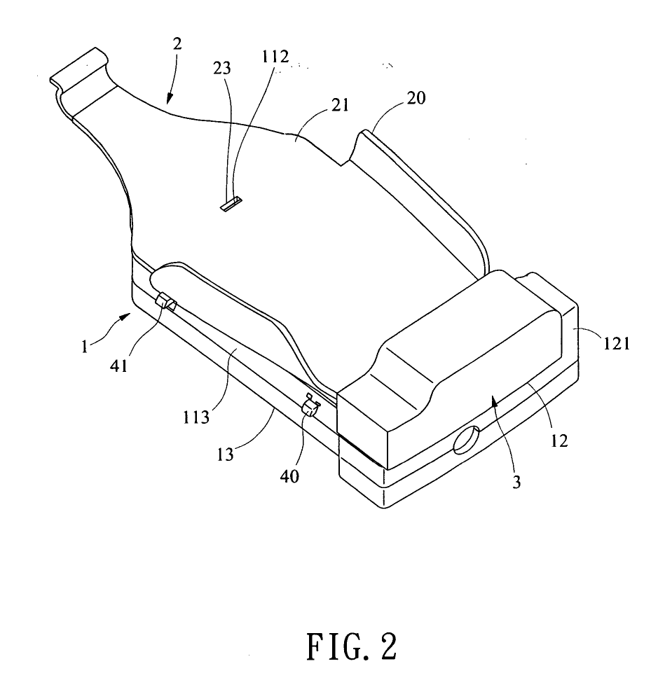

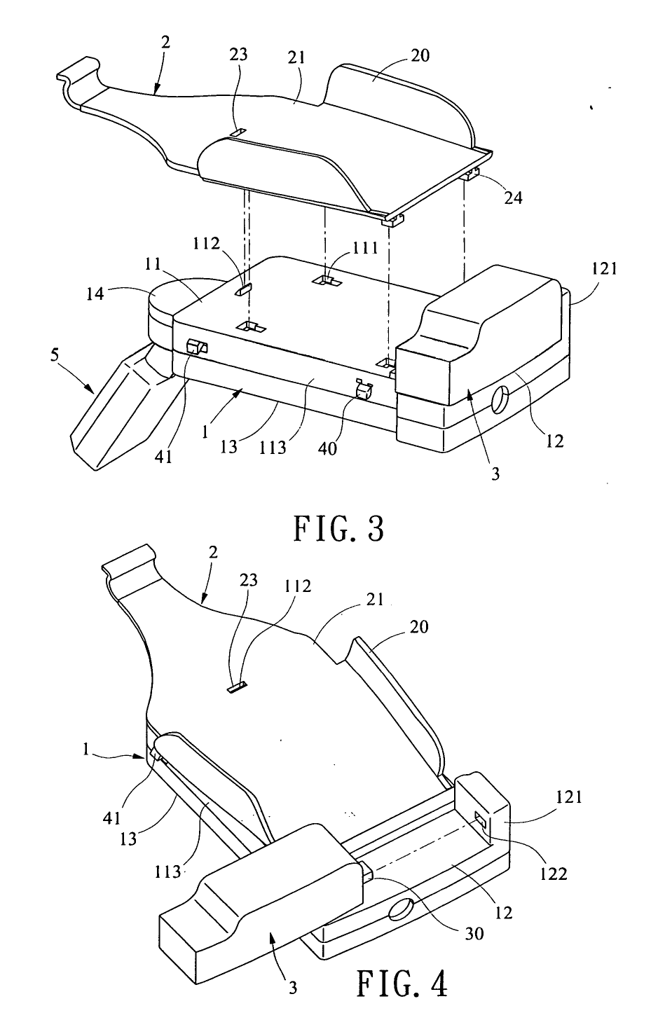

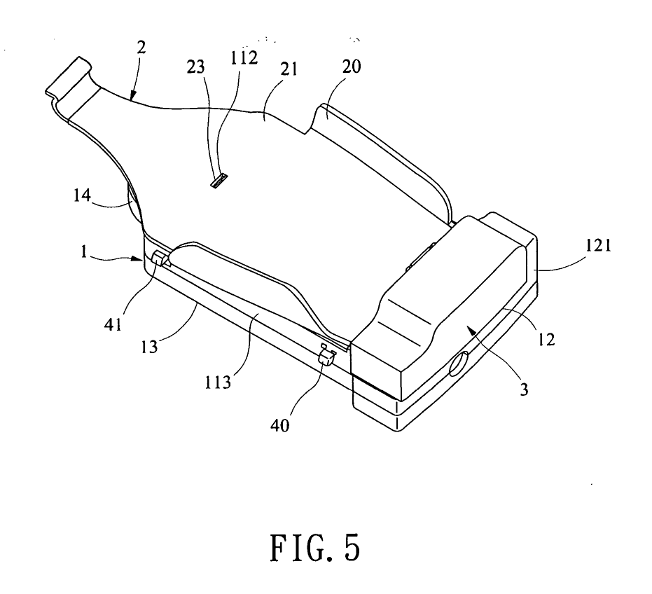

Referring to FIGS. 1 to 10, there is shown a universal device constructed in accordance with a first preferred embodiment of the invention. The universal device comprises a main body 1 having a plurality of connecting sections adapted to selectively couple to one or more of a cradle 2, a communication unit 3, a transceiver unit 5, and a coupling assembly 6 depending on applications. Each component will be described in detailed below.

As shown in FIG. 1, the main body 1 is a parallelepiped and comprises a upper plate 11, a signal processing module 12 extended from the rear end, a joint 14 extended from the front end, and a lower plate 13 with a built-in sound amplification unit 4 and a coupling assembly 6 mounted thereon.

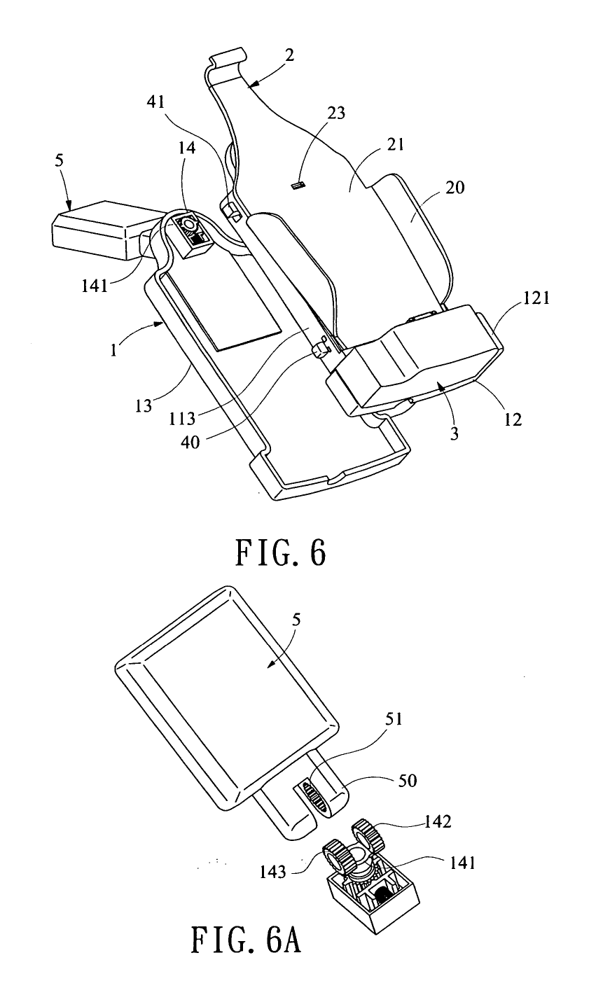

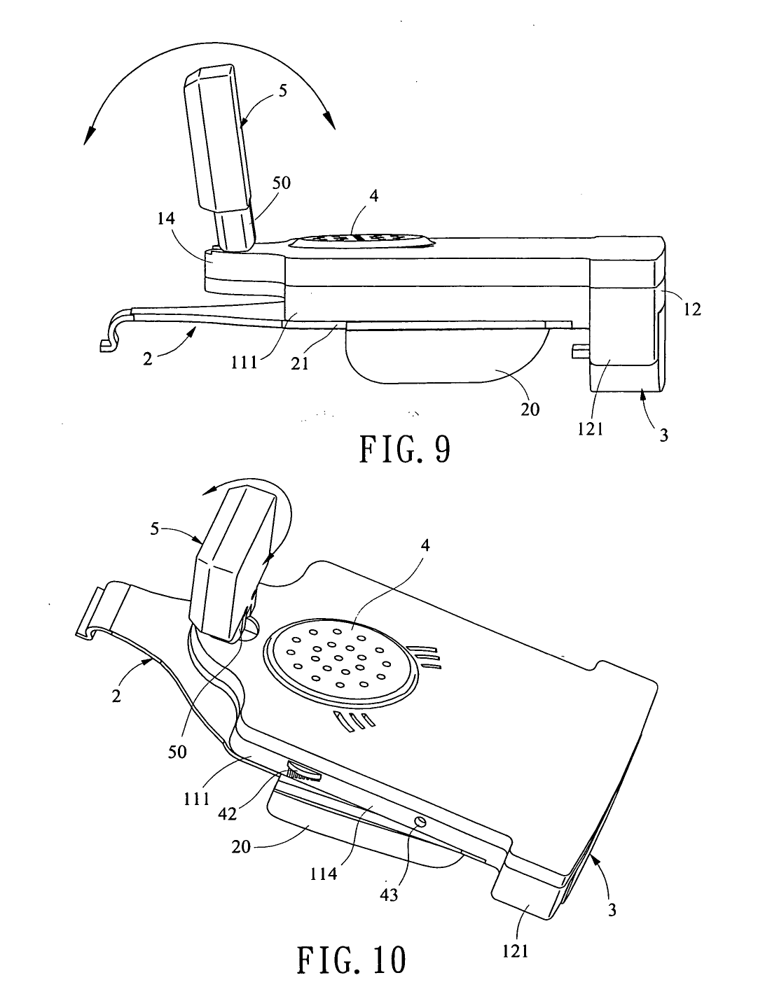

On the upper plate 11 there are provided a plurality of T-shaped slots (e.g., four proximate four corners) 111 and a tab 112 proximate the front end of the main body 1. The parallelepiped signal processing module 12 comprises an upward extension 121 having an aperture 122 on its inner side. The communication unit 3 is substantially shaped to conform to the signal processing module 12 and comprises a plug 30 protruded from one side. The plug 30 is adapted to snugly fit in the socket 122 for releasably coupling the communication unit 3 and the signal processing module 12 together. The joint 14 comprises a swivel shaft 141 on its bottom and two gears 142, 143 at opposite sides of the swivel shaft 141. As shown in FIGS. 1, 6, and 6A, the transceiver unit 5 is implemented as a wireless transceiver or a piece of GPS equipment. The transceiver unit 5 comprises a bifurcation 50 extended from one side facing the swivel shaft 141 and two annular toothed members 51 recessed into the branches of the bifurcation 50. The gears 142, 143 are adapted to fit into the toothed members 51 to be in gear connection therewith such that the transceiver unit 5 is able to turn on a pivot crossing centers of the gears 142, 143 and the toothed members 51 (see FIG. 9) or turn on the swivel shaft 141 (see FIG. 10) in an angle adjustment operation. By configuring as above, signal receiving and transmission of the transceiver unit 5 can be improved greatly.

The cradle 2 is a substantially rectangular plate having a head with a reduced size. The cradle 2 further comprises two side flanges 20 for defining a space 21 therebetween, a portable electronic device such as a cellular phone, a PDA, a Smart Phone, and a Palmtop thereon being adapted to rest on the space 21, fastened by the flanges 20, and electrically coupled to the portable electronic device held by the cradle 2, a plurality of tabs having a section of T (e.g., four proximate four corners) 24, and an aperture 23 between two front tabs 24. The tabs 24 are inserted into the slots 111 and the tab 112 is inserted into the aperture 23 when the cradle 2 is mounted on the upper plate 11. The T-shaped slots 111 and the T-shaped tabs 24 are so designed to facilitate the securing of the cradle 2 to the upper plate 11 as well as a disengagement thereof.

It is contemplated that the cradle 2 and the upper plate 11 may be releasably secured together by magnetic means elastically and snugly fitting means, or the like in other embodiments.

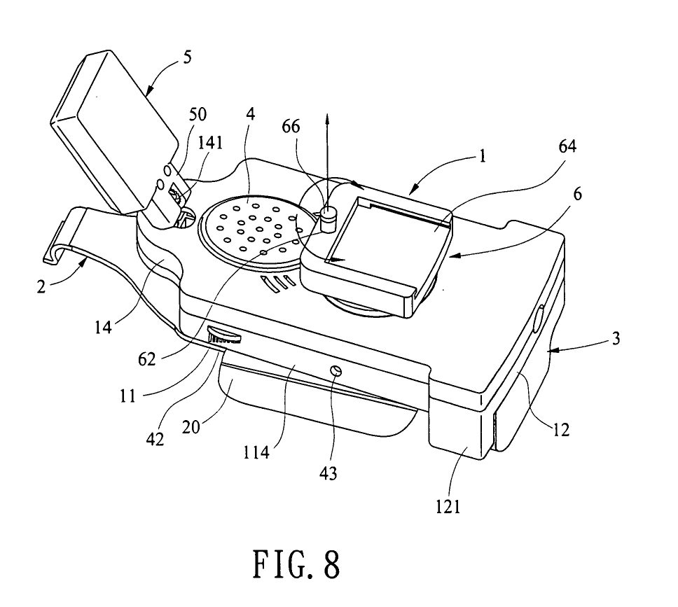

The sound amplification unit 4 is implemented as a built-in speaker. The speaker 4 is enabled or disabled by turning on or off a power switch 40 on one side 113 of the upper plate 11 (see FIGS. 1-3). On the same side 113, there is provided a selector 41 electrically coupled to the speaker 4 and the power switch 40 such that a manipulation of the selector 41 will enable a radio, a car stereo, or an external stereo to electrically connect to the speaker 4 and cause it to amplify its sound. Moreover, as shown in FIG. 8, a volume control 42 and a jack 43 are provided on the other side 114 of the upper plate 11 in which an earphone may insert into the jack 43.

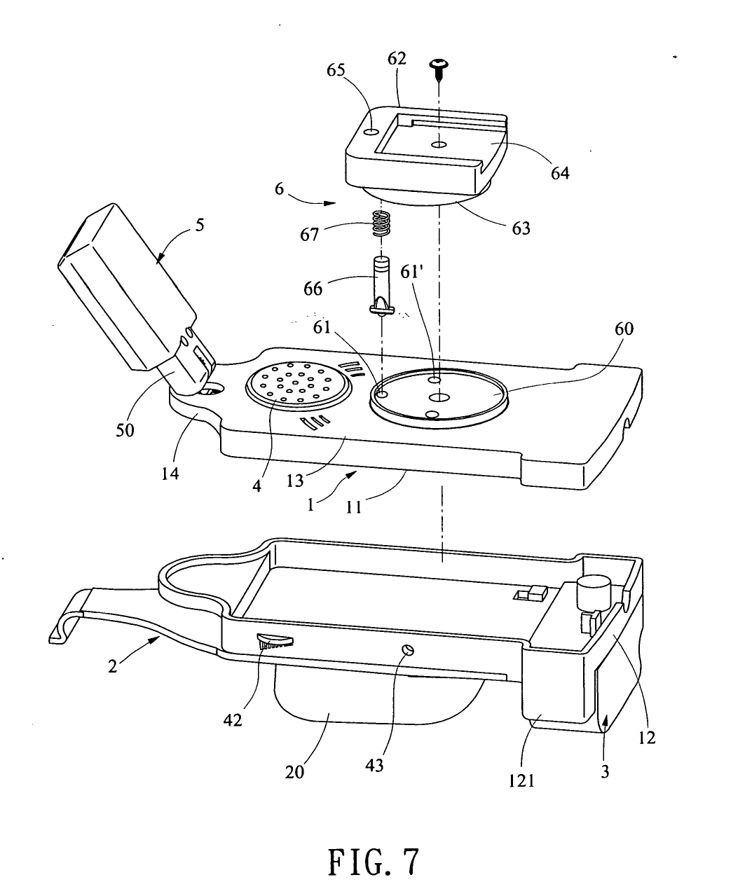

The universal device is adapted to couple to a hands-free device by means of the swivel coupling assembly 6 as shown in FIGS. 7 and 8. The coupling assembly 6 comprises a disk-shaped seat 60 fixedly formed on the lower plate 13 of the main body 1, a plurality of apertures 61 provided in the seat 60, an upper connecting member 62 rotatably secured to a center hole of the seat 60 by means of a fastener, a lower disk-shaped mount 63 fitted onto the seat 60, a cavity 64 formed on the connecting member 62 for anchoring a member to be held (not shown) thereon, a through hole 65 on a side of the connecting member 62, a pin 66 having a lower end engaged with one of the apertures 61, and a spring 67 put on the pin 66, the spring 67 together with the pin 66 anchored in the through hole 65. The lower end of the pin 66 is adapted to move from one aperture 61 to a desired one by pressing and turning the connecting member 62 with respect to the seat 60. After positioning the pin 66 at the desired aperture 61, a releasing of the connecting member 62 will cause the spring 67 to exert a stored elastic force onto the pin 66 to fasten the connecting member 62. By doing so, it is possible of adjusting a relative position of the connecting member 62 with respect to the main body 1 (see FIG. 8).

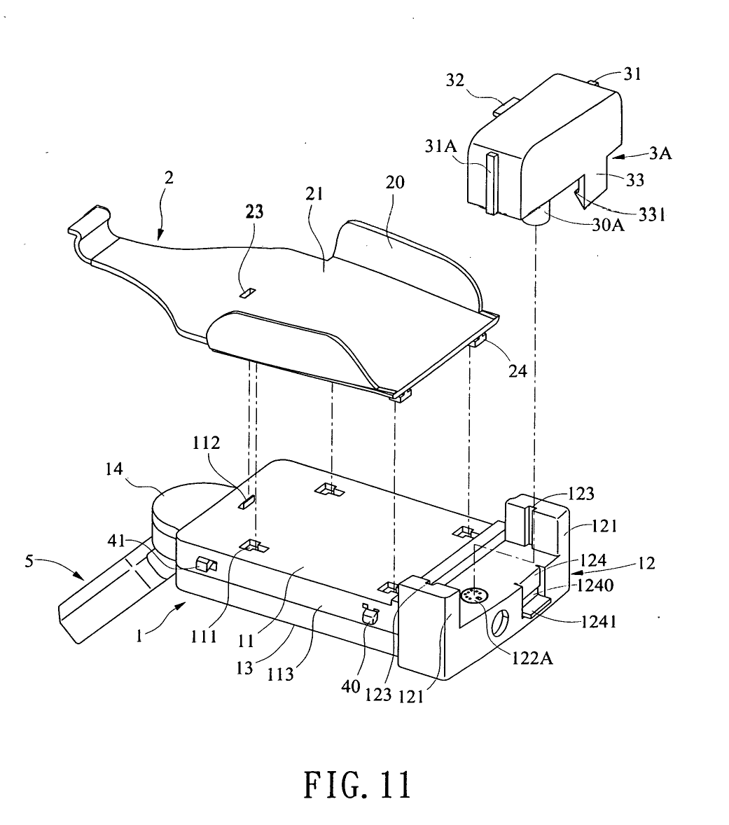

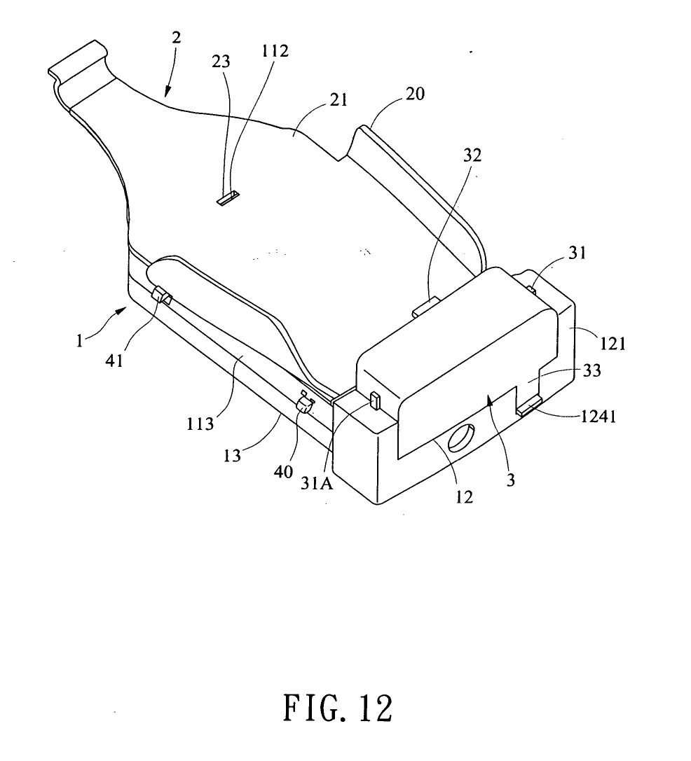

Referring to FIGS. 11 and 12, there is shown a constructed in accordance with a second preferred embodiment of the invention. The second preferred embodiment substantially has same structure as the first preferred embodiment. The characteristics of the second preferred embodiment are detailed below. The communication unit 3 is replaced by communication unit 3A and the parallelepiped signal processing module 12 further comprises two upward extensions 121 at two sides, respectively and each of them having a vertical guiding recess 123 on its inner side, an inserted socket 122A disposed on its top surface, and an elastic locking member 124 provided at a its rear portion. The locking member 124 comprises a L-shaped member having a vertical portion and a horizontal portion in which a locking groove 1240 is provided between the vertical and horizontal portions and an outer end of the horizontal portion is served as a locking released button 1241. The communication unit 3A is also substantially shaped to conform to the signal processing module 12 and further comprises a plug 30A protruded from its underside with respective to the socket 122A, a projection socket 32 at its front portion for connection to the portable electronic device, a guiding rib 31-31A at either side thereof with respect to the guiding recess 123-123, and a locking tab 33 extending from a rear underside thereof having a locking hook 331 at its lower end. In this way, the plug 30A is adapted to snugly fit in the socket 122A for releasably coupling the communication unit 3A and the signal processing module 12 together by the way of the guiding ribs 31-31A being guided with respect to the guiding recesses 123-123, and the locking hook 331 being locked at the locking groove 1240.

While the invention herein disclosed has been described by means of specific embodiments, numerous modifications and variations could be made thereto by those skilled in the art without departing from the scope and spirit of the invention set forth in the claims.

What is claimed is:

1. A universal device comprising:
a main body comprising a plurality of connecting sections including an upper plate and a lower plate;
a cradle releasably coupled to both the upper plate and a portable electronic device held thereon;
a signal processing module extended from a rear end of the upper plate; and
a communication unit releasably coupled to the signal processing module and being adapted to electrically coupled to the portable electronic device.

2. The universal device of claim 1, wherein the upper plate comprises a plurality of first slots and at least one first tab.

3. The universal device of claim 2, wherein the cradle is a substantially rectangular member and comprises two side flanges, a space defined by the flanges for holding the portable electronic device thereon, a plurality of second tabs insertable into the first slots, and at least one second slot adapted to receive the first tab.

4. The universal device of claim 1, further comprising a sound amplification unit formed on the lower plate and a power switch formed on one side of the upper plate, wherein the sound amplification unit is adapted to enable for amplifying sound from a radio or a car stereo by turning on the power switch.

5. The universal device of claim 1, further comprising a joint formed at a front end of the main body, the joint comprising a swivel shaft and two gears at opposite sides of the swivel shaft, and a transceiver unit comprising a bifurcation extended from one side thereof and two annular toothed members recessed into branches of the bifurcation, and wherein the gears are adapted to fit into the toothed members to be in gear connection therewith such that the transceiver unit is capable of turning on a pivot crossing centers of the gears and the toothed members or turning on the swivel shaft in an angle adjustment operation.

6. The universal device of claim 5, wherein the transceiver unit is a piece of GPS equipment.

7. The universal device of claim 5, wherein the transceiver unit is a wireless transceiver.

8. The universal device of claim 1, further comprising a swivel coupling assembly formed on the lower plate, the coupling assembly being adapted to hold a hands-free device thereon.

9. The universal device of claim 8, wherein the coupling assembly comprises a disk-shaped seat fixedly formed on the lower plate, a plurality of apertures provided in the seat, an upper connecting member rotatably secured to the seat, a lower disk-shaped mount fitted onto the seat, a cavity formed on the connecting member for holding the hands-free device thereon, a through hole on a side of the connecting member, and a spring depressible detent projected from the through hole, and wherein a lower end of the detent is adapted to move from one aperture to another aperture by pressing and turning the connecting member with respect to the seat.

10. The universal device of claim 2, wherein the cradle is engaged with the main body by means of a magnetic means.

11. The universal device of claim 2, wherein the cradle is engaged with the main body by means of an elastically and snugly fitting means.

12. The universal device of claim 1, wherein the signal processing module comprises an upward extension having an aperture on its inner side, and the communication unit is substantially shaped to conform to the signal processing module and comprises a plug protruded from one side.

13. The universal device of claim 1, wherein the signal processing module further comprises two upward extensions at two sides, respectively and each of them having a vertical guiding recess on its inner side, an inserted socket disposed on its top surface, and an elastic locking member provided at a its rear portion.

14. The universal device of claim 1, wherein the locking member further comprises a L-shaped member having a vertical portion and a horizontal portion wherein a locking groove is provided between the vertical and horizontal portions and an outer end of the horizontal portion is served as a locking released button.

15. The universal device of claim 13, wherein the communication unit further comprises a plug protruded from its underside with respective to the socket, a projection socket at its front portion for connection to a portable electronic device, a guiding rib at either side thereof with respect to the guiding recess, and a locking tab extending from a rear underside thereof having a locking hook at its lower end.
